(19) United States
(12) Patent Application Publication
(10) Pub. No.: US 2006/0117319 A1
(43) Pub. Date: Jun. 1, 2006

(54) Connection of an application to a resource manager selected from a plurality of resource managers

(76) Inventors: Malcolm David Ayres, Romsey (GB); Matthew Kelvin Vaughton, Hursley (GB); Graham Derek Wallis, West Wellow (GB)

Correspondence Address: IBM CORPORATION;INTELLECTUAL PROPERTY LAW, 11400 BURNET ROAD, AUSTIN, TX, 78758, US

(21) Appl. No.: 11/272,517

(22) Filed: Nov. 10, 2005

(30) Foreign Application Priority Data
Nov. 27, 2004 (GB) 0426123.6

(51) Int. Cl. G06F 9/46

(52) U.S. Cl. 718/104

(57) ABSTRACT

Disclosed is a method, apparatus and computer program for determining which resource manager of a plurality of resource managers are suitable for an application to connect to, one or more resource managers being suitable. A request is received from an application for a connection to a resource manager. Application hint data is accessed indicating the application's likely usage of at least one resource, each resource being owned by one of the plurality of resource managers. It is then decided which of the plurality of resource managers are suitable for the application to connect to given the application hint data, one or more resource managers being suitable.

### FIELD OF THE INVENTION

The present invention relates to the connection of an application to a resource manager selected from a plurality of resource managers.

### BACKGROUND OF THE INVENTION

A bus may contain many resource managers that are inter-connected such that every resource manager in the bus has at least one route to every other resource manager in the bus.

For ease, the following explanation will be given in terms of messaging engines and a messaging bus. It should however be appreciated that the invention is not limited to such.

A messaging engine typically permits an application to retrieve information from a destination (e.g. via get message request from queue x), to request processing of some work (e.g. a put message request to queue y, requesting the update of a database) and to connect to another messaging engine via the bus in order to access a destination (e.g. queue) owned by such a messaging engine. The bus provides location transparency, enabling an application connected to one engine in the bus to reach any part of the bus via that engine. See for example, http://www.sonicsoftware.com/news_events/docs/the451_{—}022304.pdf

An application may use a set of properties to control how they wish to be connected to a resource manager. These properties can contain such information as the name of the bus and the type of protocol to use. With no other constraints, in principle an application, desiring access to a particular destination (owned by a particular messaging engine), can connect to any of the messaging engines and then use the bus to access the required destination. However, while this will work functionally, connecting to an arbitrary engine may be undesirable in some situations. In such a situation, one engine (or a subset of engines) may be more suitable than the other engines connected to the bus.

It is known in the web environment to make use of cookies. When a user connects to a web server (possibly via a load balancer such Network Dispatcher from IBM), the user performs some sort of processing such as the addition of items to a shopping basket. When the user exits the web server, that server may store information about the user in a cookie and transmit that information to the user. This cookie may be used subsequently to retrieve information about the user when they reconnect. This information is not however used to direct a user to a particular web server where there is a choice of web servers and the solution also relies on a user having previously visited the web server. In other words, this solution relies on historic information.

It is also known (Network Dispatcher) to examine the contents of a URL and to use this to direct a client application to a server optimised for dealing with the type of content (e.g. image files) requested by the application.

HTTP Re-direct technology is also known, but this is simply a forwarding mechanism. The server re-directs a client browser to another URL because, for example, the server has moved.

### SUMMARY OF THE INVENTION

According to a first aspect, there is provided a method for determining which resource manager of a plurality of resource managers are suitable for an application to connect to, one or more resource managers being suitable, the method comprising: receiving a request from an application for a connection to a resource manager; accessing application hint data indicating the application's likely usage of at least one resource, each resource being owned by one of the plurality of resource mangers; and deciding which of the plurality of resource managers are suitable for the application to connect to given the application hint data, one or more resource managers being suitable.

The application can then preferably be connected to one of the resource managers.

Thus it is possible for hints about an application's usage of a particular resource to be used in deciding which resource manager to connect an application to. In a preferred embodiment, the resource manager is a messaging engine and a resource is a destination such as queue. Another example of a resource manager might be a resource manager owning a database.

The use of hint data provides for a flexible solution. If a resource is moved, then the next time an application requests a connection to one of the resource managers from the plurality, the hint data may be used to connect that application to a different resource manager from that previously connected to. In this way, it does not matter if resources are moved around since the hint data can preferably be used to achieve a decent level of performance.

The application hint data may be accessed remotely or may be received as part of the connection request.

Application hint data may specify, for example, that although an application may use several resources an application is a heavy user of a particular resource. Having accessed such information, directory information is preferably accessed to determine the location of this resource. It is then preferably determined that a resource manager which is at least in the vicinity of the resource is suitable for the application to connect to. The application is then preferably connected to resource manager owning the resource (or at least in the vicinity of the resource).

Administrator defined information may also be used to decide via which of the plurality of resource managers to connect the application to.

For example, such information may specify a group to which the chosen resource manager must/should preferably belong.

Preferably it is possible to resolve any conflict between the requirements specified by application hint data and by administrator defined information.

According to a second aspect, the invention provides an apparatus for determining which resource manager of a plurality of resource managers are suitable for an application to connect to, one or more resource managers being suitable, the apparatus comprising: a receiving component for receiving a request from an application for a connection to a resource manager; an accessing component for accessing application hint data indicating the application's likely usage of at least one resource, each resource being owned by one of the plurality of resource mangers; and a deciding component for deciding which of the plurality of resource managers are suitable for the application to connect to given the application hint data, one or more resource managers being suitable.

According to a third aspect, the invention provides a method for hinting which of a plurality of resource managers are suitable for connecting an application to, one or more resource managers being suitable, the method comprising; requesting a connection to a resource manager; providing access to application hint data indicating the application's likely usage of at least one resource, each resource being owned by one of the plurality of resource managers; and being informed that one or more of the plurality of resource managers are suitable.

According to a fourth aspect, the invention provides an apparatus for hinting which of a plurality of resource managers are suitable for connecting an application to, one or more resource managers being suitable, the apparatus comprising; a requesting component for requesting a connection to a resource manager; an access provider for providing access to application hint data indicating the application's likely usage of at least one resource, each resource being owned by one of the plurality of resource mangers; and means for being informed that one or more of the plurality of resource managers are suitable.

In one embodiment the method/apparatus is informed of that a resource manager is suitable because a connection with that resource manager is initiated by another entity.

Preferably the application hint data because it is hint data only, may be ignored in certain circumstances.

The invention may be implemented in computer software.

### BRIEF DESCRIPTION OF THE DRAWINGS

A preferred embodiment of the present invention, will now be described, by way of example only, and with reference to the following drawings:

FIG. 1 shows the components of a preferred embodiment of the present invention;

FIG. 2 illustrates the processing of the present invention in accordance with a preferred embodiment of the present invention;

FIG. 3 illustrates, in accordance with a preferred embodiment, the TRM component of FIG. 1 in more detail;

FIG. 4 shows, in accordance with a preferred embodiment of the present invention, the WLM component of FIG. 1 in more detail;

FIGS. 5a and 5b depict, in accordance with a preferred embodiment of the present invention, application 60 and the JNDI component of FIG. 1; and

FIG. 6 illustrates further processing of the present invention, in accordance with a preferred embodiment.

### DETAILED DESCRIPTION

Below is provided a glossary of the terms used throughout the specification. Such a glossary is not intended to be limiting on the present application but is provided to aid explanation:

Glossary

Host: Computer
Node: “Virtual Host”—A host may be partitioned into one or more nodes, each with their own identity
Process: A context within an operating system having its own address space. Each process runs within a node and one or more processes typically collaborate to provide an application. For example, one process may display a GUI, whilst another may print a file.
Application: One or more processes working together to provide some functionality—e.g. email capability.
   Application
Server: The means by which an application may be executed.
Bus: The means by which a set of resource managers may be connected together for the purpose of communicating with one another.
   Messaging Engine
(ME) The means by which each application server connects to a bus and achieves the processing of work/retrieval of information.
Destination: A location (e.g. queue) via which work may be requested and/or processed.

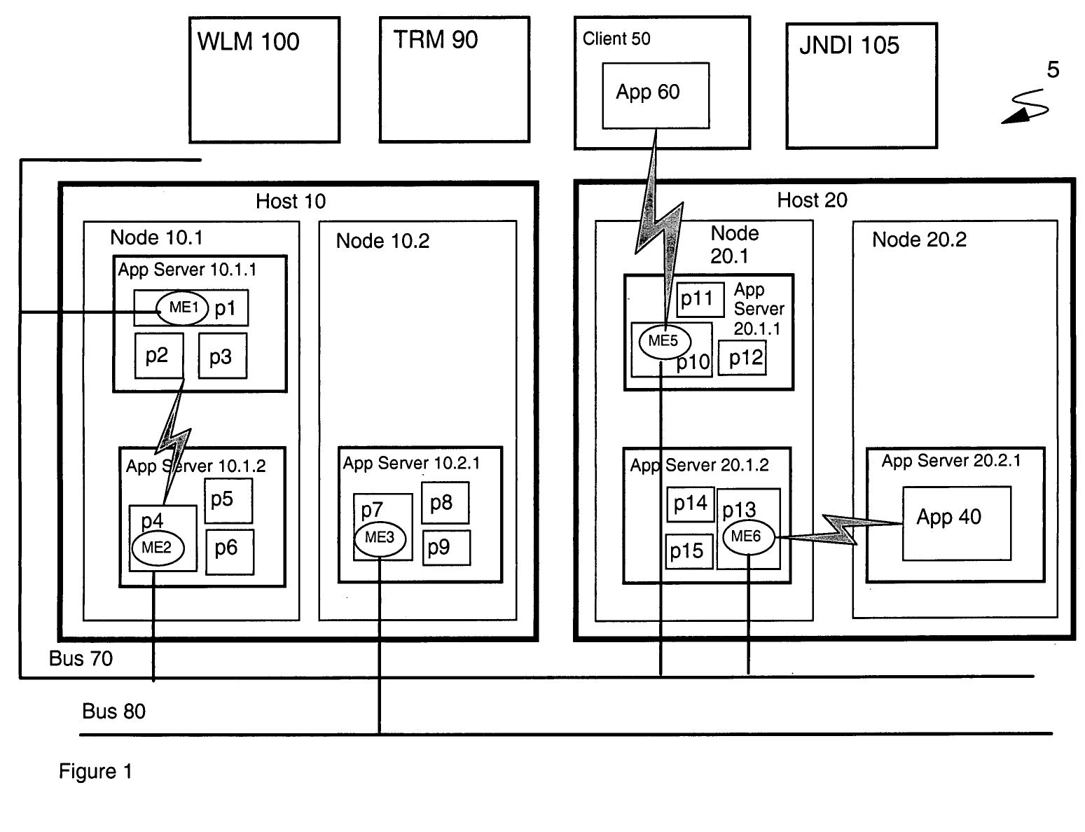

The present invention operates, in accordance with a preferred embodiment, in the environment shown in FIG. 1. A system 5 is shown having a plurality of hosts 10, 20. A host may accommodate one or more individually addressable nodes. Host 10, for example has two nodes 10.1, 10.2, whilst host 20 has two nodes 20.1, 20.2. Each node has at least one application server 10.1.1, 10.1.2, 10.2.1, 20.1.1, 20.1.2, 20.2.1. Each application server typically executes one or more processes which collaborate together to provide application functionality 40, 60. For example application server 10.1.1 executes processes p1, p2, p3 (which together denote an application—not referenced), whilst application server 10.1.2 executes processes p4, p5, p6. The processes making up applications 40 and 60 do exist but are not shown in the figure.

Certain processes run a messaging engine (ME) thereby enabling an application to access the destinations owned by the ME and to connect to a bus 70, 80 in order to access destinations owned by other MEs. For example p1 on application server 10.1.1 executes ME1 which owns destinations (not shown) and which provides a connection to bus 70.

Via busses 70 and 80, application servers are able to communicate with one another.

Client 50 also runs an application 60 which communicates with ME5 and is thus able to access bus 70 this way. An application, such as the application formed by p1, p2 and p3, is able to use its own in-process ME (ME1) to request the processing of work and to gain access to the bus, or it is able to communicate directly with another ME (e.g. ME2) in order to get access to the bus. It is however likely to be more efficient to use an application's in-process ME if this is possible in order to get access to the bus.

The present invention, in accordance with a preferred embodiment, determines which messaging engine an application should connect to based on the work that the application intends to do.

TRM (Topology Routing Manager) component 90 collaborates to achieve a connection request with a WLM component 100 and a Java™ Naming Directory Interface (JNDI) component 105 (Java and all Java-based trademarks and logos are trademarks of Sun Microsystems, Inc. in the United States, other countries, or both). WLM keeps track of all the constituent parts of the environment described with reference to FIG. 1.

Note, there may be more than one WLM, each WLM being responsible for a subset of the environment—E.g. A group of hosts, nodes or application servers.

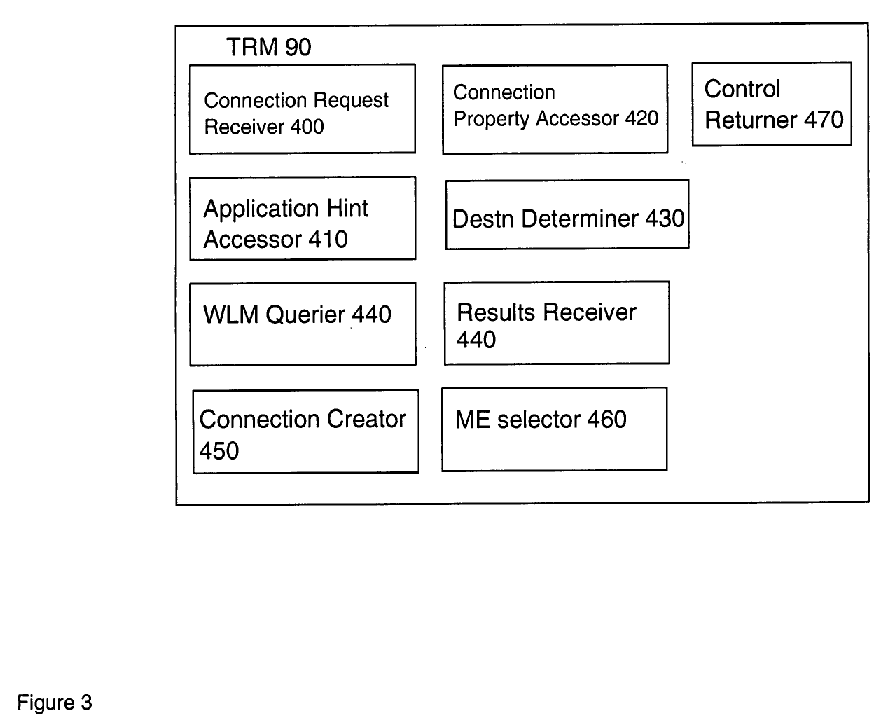

WLM will be described in more detail with reference to FIG. 3 but preferably provides directory information and also selects possible MEs via which an application may request the processing of work and may connect to a particular bus.

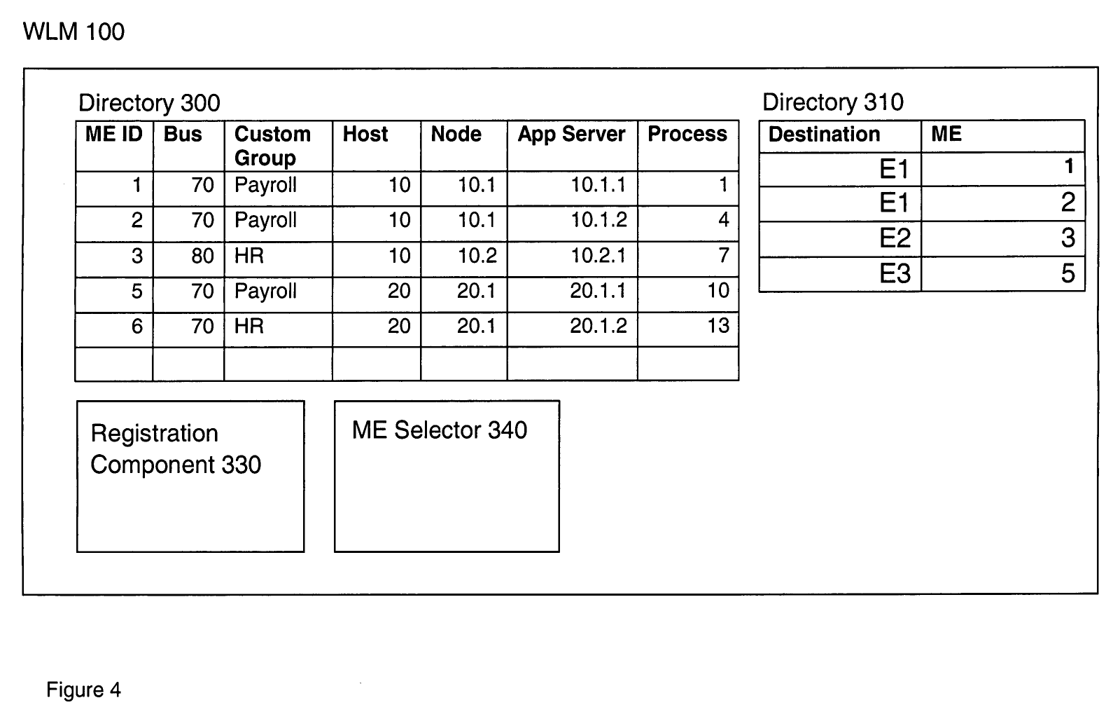

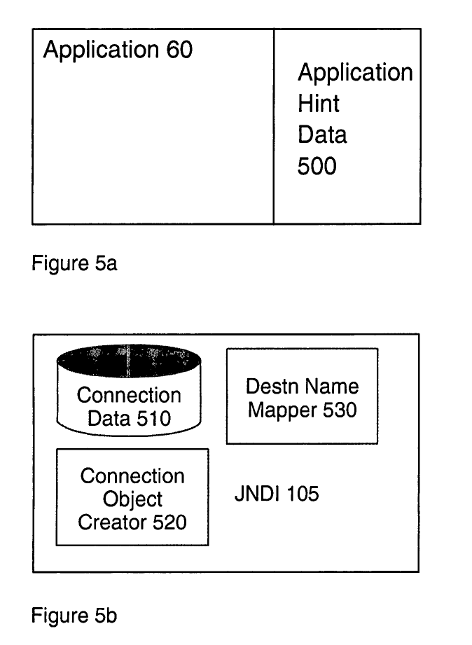

TRM will be described with reference to FIG. 4 and JNDI component 105 with reference to FIG. 5b. An application will be described in more detail with reference to FIG. 5a.

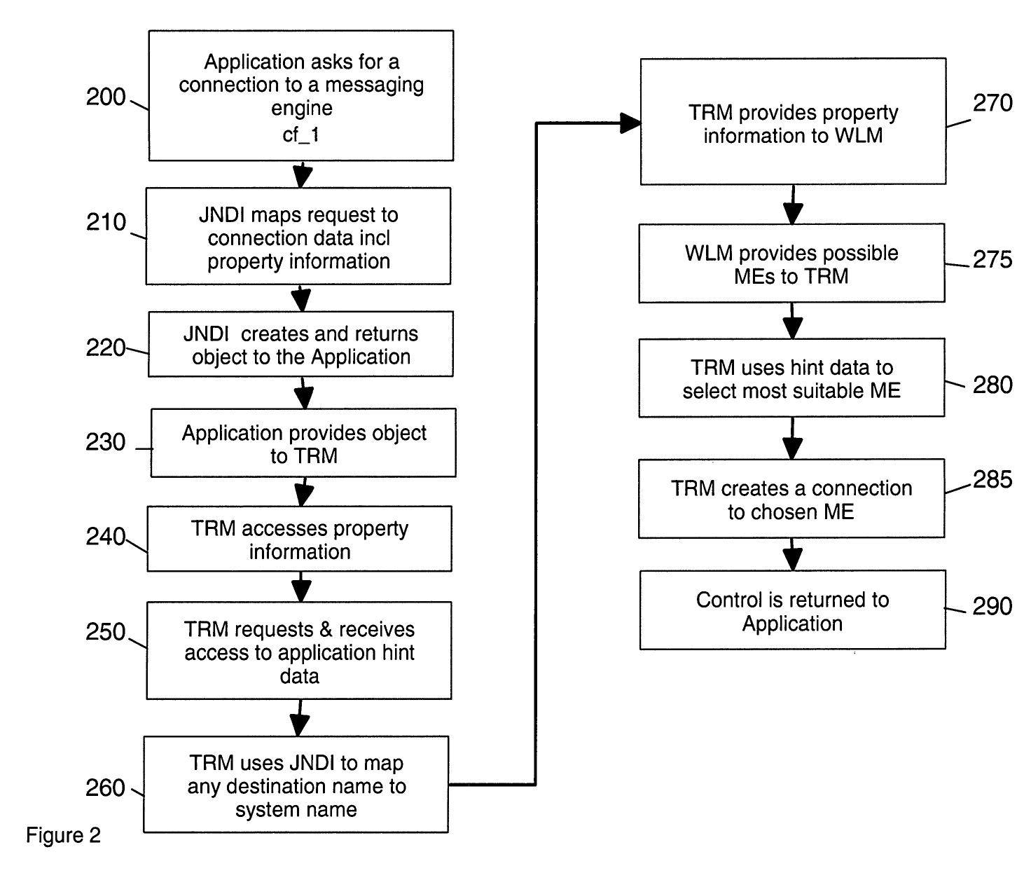

The processing of the present invention, in accordance with a preferred embodiment, will now be described with reference to FIG. 2. This figure should be read in conjunction with FIGS. 3, 4, 5a and 5b.

At step 200 application 60 requests a connection to a messaging engine. This is achieved by requesting a connection factory object (cf_1) from JNDI component 105. JNDI maps the request to connection data 510 including connection property information (step 210). From this connection data, JNDI creates a connection factory object (connection object creator 520) and returns this to application 60 (step 220). Note, the bus which the application may use to connect to other MEs is part of the information contained within the connection factory object returned by JNDI. Thus this is something that was configured by a system administrator.

The connection factory object includes the connection property information. Connection property information is preferably of the form “target name; target significance”. Connection property information is administrator specified. The target name property specifies that a selected ME should/must be part of a particular “custom group”. The custom group function permits a system administrator to group MEs together according to, for example, some common function. For example, there may be a “payroll” custom group and also an “HR” custom group. The target significance property may take the value “preferred” or “required”. A value of “preferred” means that it is preferred, but not mandatory that a chosen ME be within the specified target group. A value of “required”, on the other hand, makes it mandatory that a chosen ME be within the specified target group.

Having received a connection factory object including connection property information, application 60 provides this object to TRM (step 230). This is received by connection request receiver 400. TRM accesses, via connection property accessor component 420, the property information contained within the received object (step 240). TRM then requests and receives access to application 60's hint data 500 (application hint accessor 410, step 250). Application hint data is preferably provided by the application software developer as an extension to the main application. The hint data provides clues as to which destinations (e.g. queues) are important to the application for the purpose of putting messages thereto and getting messages therefrom for processing. The developer understands the way in which the application works, including the way in which the application uses destinations (Destn) to put messages to and to get messages therefrom. Thus the developer is best placed to provide such hint data. Hints may be of the form “Heavy User of Destn E7, light user of Destn E3. Hint information may be used by the TRM component as a factor when recommending/dictating which ME an application should connect to. If an application is a particularly heavy user of E7, then it makes sense to choose a particular ME over another if the particular ME is closest to (or contains) the heavily used E7. Note, the ME chosen may not contain a destination which the application needs to access, but the application can use the bus to access the appropriate ME and therefore destination.

Thus TRM component 90 accesses application hint data. The hint data, in the preferred embodiment, refers however to each destination by a name defined by the application developer. Such names are not necessarily names that make any sense upon deployment. Thus JNDI component 105 is used to map any destination names to system names (step 260, Destn Mapper 530). Note, steps 250 and 260 may be performed after step 275.

TRM component 90 provides the administrator specified property information to WLM component 100 (step 270).

As alluded to earlier, WLM maintains directory information 300, 310 about the environment in which it operates. When a messaging engine connects to a bus, it registers with WLM. WLM includes a registration component 330 and when a messaging engine connects to a bus, that engine registers with WLM using component 330. Such a registration involves providing, by way of example, WLM with the following information:

ME id; bus name; custom group; host id; node id; application server id; and process id.

The ME knows its own id and the name of the bus that it connects to. The ME queries its owning process for its process id, the process queries its application server for an application server id, the ME queries whether it is part of a custom group and so on. In this way, suitable information is provided to the ME and the ME in turn provides this to WLM upon registration.

Such information is then stored by WLM in directory 300. Thus it can be seen that ME1 connects to bus 70, is part of custom group “payroll”, is owned by process 1, within application server 10.1.1. That application server is on node 10.1 and the node sits on host 10.

ME selector component 340 uses the information provided by TRM and directory information 300 to extract the names of any MEs that satisfy the custom group criterion. For example, if the custom group is specified as “payroll”, then component 340 returns ME1 and ME2 and ME5. Note, the property information also contains a target significance value. If the value is “required” and no MEs exist within the specified target group, then the selector component 340 is unable to return anything to TRM. If on the other hand, the significance is only “preferred”, then another ME falling outside the custom group may be returned.

Thus MEs are selected and are returned to TRM (step 275). TRM then uses the application hint data to select one ME from the potential set returned (step 280). In order to do this TRM has to find out from WLM where any destinations specified in the hint information are located. Directory 310 provides this information. Note, destinations may be partitioned and thus be located within more than one ME.

For ease of explanation, an example will now be provided. Application 60 requests a connection to a messaging engine. Administrator connection properties specify that an ME within the custom group “payroll”, is required. Thus the ME selector component returns MEs 1, 2 and 5 as possibilities. TRM then uses application hint data to make an appropriate selection. The hint data indicates that application 60 is a heavy user of destination E3 and a light user of E1 (the hint specified destinations having been mapped by JNDI). TRM therefore selects ME5 as the most suitable messaging engine. This is because from directory 310 it is apparent that E3 is directly accessible via ME5.

Of course, a destination may not be directly accessible via a messaging engine (i.e. the destination may not be contained within a suitable ME), however in this instance a messaging engine with the best proximity to the particular destination is preferably selected. This can be determined from directory information 300. Alternatively the hint and administrator information may in certain circumstances be ignored.

Note, TRM does not have to make the final selection. For example, WLM could receive hint information from TRM and make that selection. By way of another example, the application (or the client on which it resides) could make the selection. All/some of the directory information does not have to be held by WLM, instead JNDI could hold such details. Many other variations are possible.

However, once an ME has been selected TRM preferably creates a connection to the chosen ME (step 285). Control is then returned to the application (step 290).

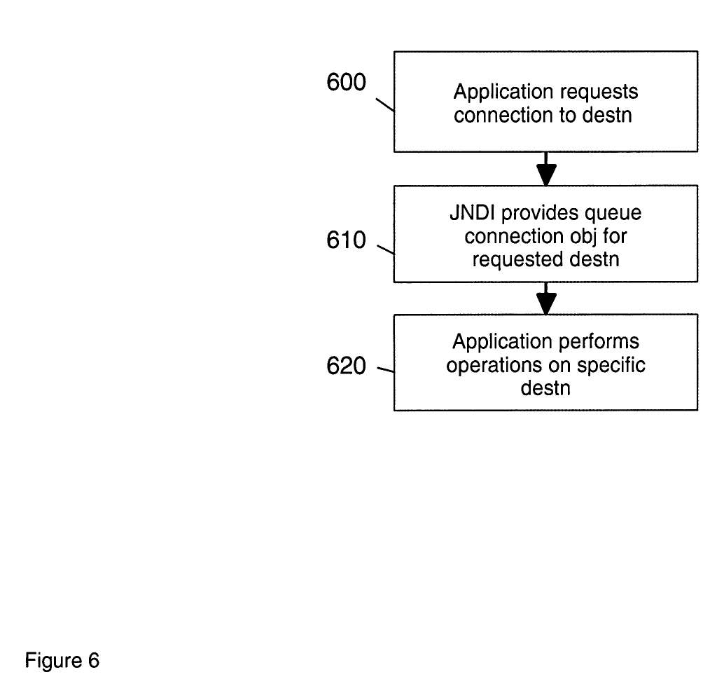

FIG. 6 illustrates processing, in accordance with a preferred embodiment, once a connection with an ME has been established. The Application requests a connection to a particular destination (step 600). JNDI provides a queue connection factory object to the application (step 610). The application is then able to use this object to perform operations on the requested destination (step 620). For example the application may put a message to the destination or get a message from that destination.

It should be appreciated that whilst the present invention has been described in terms of using administrator specified information and also application hint data in order to decide where to connect an application to a bus, this is not necessarily the case. For example, hint data may be used alone. Equally, the administrator specified information may be used without the hint data.

Note, whilst the present invention has been described in terms of messaging and messaging engines, the invention is not limited to such. Rather, the invention may apply to any set of connected resource managers and their resources.

Further note, there may be a conflict between information specified by the administrator defined information and that specified by the application data. In which case rules can be used to specify which one should prevail over the other.

Note, once an application has a connection to an ME, the application still has the ability to put/get messages from any destination anywhere in the bus. It is just that remote put/gets will involve internal bus traffic so won't be as efficient as a put/get from a local destination in the same ME as the ME to which the client is connected.

Note, an application may be a heavy user of more than one destination. In this case, rules may be used to determine which messaging engine is connected to. Some indicator may be provided that one destination is used more than the other and the choice can then be made based on an ME close to that destination. Of course a hint may not simply be of the kind described above. A hint may specify that an application is a medium user of a particular destination or that a particular queue is rarely used.

1. A computer implemented method of determining which resource manager of a plurality of resource managers are suitable for an application to connect to, one or more resource managers being suitable, the method comprising:
receiving a request from an application for a connection to a resource manager;
accessing application hint data indicating the application's likely usage of at least one resource, each resource being owned by one of the plurality of resource managers; and
determining which of the plurality of resource managers are suitable for the application to connect to given the application hint data, one or more resource managers being suitable.

2. The method of claim 1, wherein the application hint data is received with the connection request.

3. The method of claim 1, wherein the step of determining which of the plurality of resource managers are suitable comprises:
determining that an application is a heavy user of a resource,
accessing directory information to determine the location of the resource; and
determining that a resource manager which is at least in the vicinity of the resource is suitable for the application to connect to.

4. The method of claim 1, further comprising:
accessing administrator defined information; and
using the administrator defined information to determine via which of the plurality of resource managers to connect the application to.

5. The method of claim 4, wherein the administrator defined information specifies a group to which the chosen resource manager must belong.

6. The method of claim 4, wherein the administrator defined information specifies a group to which the chosen resource manager should preferably belong.

7. The method of claim 4, further comprising:
resolving any conflict between application hint data and administrator specified information in order to determine which of the plurality of resource managers to connect the application to.

8. Apparatus for determining which resource manager of a plurality of resource managers are suitable for an application to connect to, one or more resource managers being suitable, the apparatus comprising:
a receiving component for receiving a request from an application for a connection to a resource manager;
an accessing component for accessing application hint data indicating the application's likely usage of at least one resource, each resource being owned by one of the plurality of resource mangers; and
a determining component for determining which of the plurality of resource managers are suitable for the application to connect to given the application hint data, one or more resource managers being suitable.

9. The apparatus of claim 8, wherein the application hint data is received with the connection request.

10. The apparatus of claim 8, wherein the determining component comprises:
a first determining component for determining that an application is a heavy user of a resource;
a directory accessing component for accessing directory information to determine the location of the resource; and
a second determining component for determining that a resource manager which is at least in the vicinity of the resource is suitable for the application to connect to.

11. The apparatus of claim 8, further comprising:
an administrator information accessing component for accessing administrator defined information; and
a component for using the administrator defined information to determining via which of the plurality of resource managers to connect the application to.

12. The apparatus of claim 11, wherein the administrator defined information specifies a group to which the chosen resource manager must belong.

13. The apparatus of claim 11, wherein the administrator defined information specifies a group to which the chosen resource manager should preferably belong.

14. The apparatus of claim 11, further comprising:
a resolving component for resolving any conflict between application hint data and administrator specified information in order to determine which of the plurality of resource managers to connect the application to.

15. The method of claim 1 further comprising hinting which of a plurality of resource managers are suitable for connecting an application to, one or more resource managers being suitable, comprising;
requesting a connection to a resource manager;
providing access to application hint data indicating the application's likely usage of at least one resource, each resource being owned by one of the plurality of resource managers; and
being informed that one or more of the plurality of resource managers are suitable.

16. The apparatus of claim 8, further comprising an apparatus for hinting which of a plurality of resource managers are suitable for connecting an application to, one or more resource managers being suitable, the apparatus for hinting comprising;
a requesting component for requesting a connection to a resource manager;
an access provider for providing access to application hint data indicating the application's likely usage of at least one resource, each resource being owned by one of the plurality of resource mangers; and
means for being informed that one or more of the plurality of resource managers are suitable.

17. A computer program comprising program code means adapted to perform a computer implemented method of determining which resource manager of a plurality of resource managers are suitable for an application to connect to, one or more resource managers being suitable, when said computer program is run on a computer, the computer program code means comprising:
computer program code means for receiving a request from an application for a connection to a resource manager:
computer program code means for accessing application hint data indicating the application's likely usage of at least one resource, each resource being owned by one of the plurality of resource managers; and
determining which of the plurality of resource managers are suitable for the application to connect to given the application hint data, one or more resource managers being suitable.
